(19) United States
(12) Patent Application Publication
(10) Pub. No.: US 2026/0080238 A1
(43) Pub. Date: Mar. 19, 2026

(54) HUMAN PRESENCE DETECTION USING CHANNEL STATE INFORMATION

(71) Applicant: Synaptics Incorporated, San Jose, CA (US)

(72) Inventors: Brendan Reidy, San Jose, CA (US); Karthikeyan Shanmuga Vadivel, San Jose, CA (US); Sai Manikanta Rishi Rani, San Jose, CA (US); Mohan Ramasudha Karnam, San Jose, CA (US); Zacchaeus Scheffer, San Jose, CA (US); Ananda Roy, San Jose, CA (US); Dmitri Lvov, Ramat Hasharon (IL); Deepak Mital, Fremont, CA (US)

(73) Assignee: Synaptics Incorporated, San Jose, CA (US)

(21) Appl. No.: 18/886,406

(22) Filed: Sep. 16, 2024

(51) Int. Cl. G06N 3/08

(52) U.S. Cl. CPC G06N 3/08

(57) ABSTRACT

Methods and apparatus for training a neural network to detect living beings in an enclosed space are disclosed. An example method includes obtaining channel state information (CSI) data based at least in part on a sequence of signals received at one or more receivers located in the enclosed space, generating training data for the neural network based at least in part on the CSI data, training the neural network using the training data to detect living beings in the enclosed space, and processing the trained neural network for deployment.

### TECHNICAL FIELD

The present implementations relate generally to wireless sensing, and more particularly to detecting living beings, such as humans, within confined spaces such as automotive interiors.

### BACKGROUND OF RELATED ART

Many existing automotives include wireless connectivity, such as including one or more wireless transmitters and one or more wireless receivers in the interior of the automotive. Such wireless connectivity may enable devices to communicate with various systems associated with the automotive. For example, such devices may communicate with an audio system of the automotive in order to play music or telephone call audio over one or more speakers within the automotive, may communicate with a Wi-Fi system of the automotive in order to communicate wirelessly with one or more remote networks, etc.

Additionally, users and operators of automotives may desire safeguards for health and safety purposes, such as the health and safety of one or more infants or small children in the automotive. For example, even on relatively cool days, infants or small children may be seriously injured or killed by being left unattended in an automotive. Temperatures in automotive interiors may rise quite quickly, and infants and small children may overheat several times more quickly than adults. Preventing injuries and deaths caused by such overheating is a longstanding goal of automotive manufacturers and safety regulators.

### SUMMARY

This Summary is provided to introduce in a simplified form a selection of concepts that are further described below in the Detailed Description. This Summary is not intended to identify key features or essential features of the claimed subject matter, nor is it intended to limit the scope of the claimed subject matter.

One innovative aspect of the subject matter of this disclosure can be implemented as a method for training a neural network to detect living beings in an enclosed space. An example method includes obtaining channel state information (CSI) data based at least in part on a sequence of signals received at one or more receivers located in the enclosed space, generating training data for the neural network based at least in part on the CSI data, training the neural network using the training data to detect living beings in the enclosed space, and processing the trained neural network for deployment.

In some aspects, the CSI data is based at least in part on a pilot signal transmitted by a transmitter and received by at least one of the one or more receivers.

In some aspects, generating the training data includes pre-processing the CSI data. In some aspects, pre-processing the CSI data includes determining an average of the CSI data over a predetermined time period, and subtracting the average of the CSI data from each signal of the sequence of signals corresponding to the predetermined time period. In some aspects, pre-processing the CSI data includes normalizing the CSI data based on an average value of the CSI data. In some aspects, pre-processing the CSI data includes augmenting the CSI data generating one or more additional sets of CSI data based on the CSI data. In some aspects, generating the one or more additional sets of CSI data includes generating one or more sped up CSI data sets by altering a timing of the CSI data to have a faster timing, or generating one or more slowed down CSI data sets by altering the timing of the CSI data to have a slower timing. In some aspects, the one or more receivers include two receivers, and the one or more additional sets of CSI data are generated by assigning a first CSI data signal received at a first receiver of the two receivers to a second receiver of the two receivers, and assigning a second CSI data signal received at the second receiver to the first receiver.

In some aspects, generating the training data includes generating the training data based on a spectral analysis of the CSI data. In some aspects, the training data is based on a Fast Fourier Transform (FFT) of the CSI data. In some aspects, the training data is based on a magnitude portion of the FFT of the CSI data. In some aspects, an FFT is calculated for each subcarrier of the CSI data.

In some aspects, training the neural network includes training the neural network to detect a human breathing in the enclosed space. In some aspects, detecting the human breathing in the enclosed space includes detecting an infant breathing in the vehicle.

In some aspects, the CSI data obtained is obtained in the presence of a plurality of test cases including various circumstances within or adjacent to the enclosed space. In some aspects, the plurality of test cases include one or more test cases where an infant is present in the enclosed space. In some aspects the one or more test cases where the infant is present in the enclosed space include at least a first test case where the infant is on a seat in the enclosed space and a second test case where the infant is on a floor in the enclosed space. In some aspects, the enclosed space is an interior of a vehicle and the plurality of test cases include one or more test cases corresponding to motion outside of the vehicle, and wherein training the neural network includes training the neural network not to detect living beings in the vehicle in response to CSI data corresponding to the motion outside of the vehicle.

Another innovative aspect of the subject matter of this disclosure can be implemented as a computing device for training a neural network to detect living beings in an enclosed space. An example computing device includes at least one data processor and a memory storing instructions which, when executed by the at least one data processor, causes the at least one data processor to perform operations including obtaining channel state information (CSI) data based at least in part on a sequence of signals received at one or more receivers located in the enclosed space, generating training data for the neural network based at least in part on the CSI data, training the neural network using the training data to detect living beings in the enclosed space, and processing the trained neural network for deployment.

Another innovative aspect of the subject matter of this disclosure can be implemented as a non-transitory computer-readable storage medium storing instructions for execution by one or more processors of a computing device.

Execution of the instructions causes the computing device to perform operations including obtaining channel state information (CSI) data based at least in part on a sequence of signals received at one or more receivers located in the enclosed space, generating training data for the neural network based at least in part on the CSI data, training the neural network using the training data to detect living beings in the enclosed space, and processing the trained neural network for deployment.

### BRIEF DESCRIPTION OF THE DRAWINGS

The present embodiments are illustrated by way of example and are not intended to be limited by the figures of the accompanying drawings.

FIG. 1 shows an example system which may gather channel state information (CSI) data in an enclosed space, according to some implementations.

FIG. 2A shows a side view of an example environment in which a Wi-Fi transmitter and one or more Wi-Fi receivers may be deployed within an automotive for detecting human presence within the automotive based on gathered CSI data, in accordance with some implementations.

FIG. 2B shows a top down view of an example environment in which a Wi-Fi transmitter and one or more Wi-Fi receivers may be deployed within an automotive for detecting human presence within the automotive based on gathered CSI data, in accordance with some implementations.

FIG. 3 shows an example process flow for training a neural network to detect living beings in an enclosed space, in accordance with some implementations.

FIG. 4 shows an example process flow depicting the use of a trained neural network for detecting living beings within an enclosed space, in accordance with some implementations.

FIG. 5 shows a block diagram of an example model training system, according to some implementations.

FIG. 6 shows a block diagram of an example presence detection system, according to some implementations.

FIG. 7 shows an illustrative flowchart depicting an example operation for detecting living beings in an enclosed space, in accordance with some implementations.

FIG. 8 shows an illustrative flowchart depicting an example operation for detecting human presences in an interior of a vehicle, in accordance with some implementations.

### DETAILED DESCRIPTION

In the following description, numerous specific details are set forth such as examples of specific components, circuits, and processes to provide a thorough understanding of the present disclosure. The term “coupled” as used herein means connected directly to or connected through one or more intervening components or circuits. The terms “electronic system” and “electronic device” may be used interchangeably to refer to any system capable of electronically processing information. Also, in the following description and for purposes of explanation, specific nomenclature is set forth to provide a thorough understanding of the aspects of the disclosure. However, it will be apparent to one skilled in the art that these specific details may not be required to practice the example embodiments. In other instances, well-known circuits and devices are shown in block diagram form to avoid obscuring the present disclosure. Some portions of the detailed descriptions which follow are presented in terms of procedures, logic blocks, processing and other symbolic representations of operations on data bits within a computer memory.

These descriptions and representations are the means used by those skilled in the data processing arts to most effectively convey the substance of their work to others skilled in the art. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system. It should be borne in mind, however, that all of these and similar terms are to be associated with the appropriate physical quantities and are merely convenient labels applied to these quantities.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

In the figures, a single block may be described as performing a function or functions; however, in actual practice, the function or functions performed by that block may be performed in a single component or across multiple components, and/or may be performed using hardware, using software, or using a combination of hardware and software. To clearly illustrate this interchangeability of hardware and software, various illustrative components, blocks, modules, circuits, and steps have been described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. Also, the example input devices may include components other than those shown, including well-known components such as a processor, memory and the like.

The techniques described herein may be implemented in hardware, software, firmware, or any combination thereof, unless specifically described as being implemented in a specific manner. Any features described as modules or components may also be implemented together in an integrated logic device or separately as discrete but interoperable logic devices. If implemented in software, the techniques may be realized at least in part by a non-transitory processor-readable storage medium including instructions that, when executed, performs one or more of the methods described above. The non-transitory processor-readable data storage medium may form part of a computer program product, which may include packaging materials.

The non-transitory processor-readable storage medium may comprise random access memory (RAM) such as synchronous dynamic random-access memory (SDRAM), read only memory (ROM), non-volatile random-access memory (NVRAM), electrically erasable programmable read-only memory (EEPROM), FLASH memory, other known storage media, and the like. The techniques additionally, or alternatively, may be realized at least in part by a processor-readable communication medium that carries or communicates code in the form of instructions or data structures and that can be accessed, read, and/or executed by a computer or other processor.

The various illustrative logical blocks, modules, circuits and instructions described in connection with the embodiments disclosed herein may be executed by one or more processors (or a processing system). The term “processor,” as used herein may refer to any general-purpose processor, special-purpose processor, conventional processor, controller, microcontroller, and/or state machine capable of executing scripts or instructions of one or more software programs stored in memory.

As described above, preventing injuries and deaths to children and infants caused by overheating in automotive interiors is a longstanding goal of automotive manufacturers and safety regulators. As such, it is desirable to notify users when an automotive has been left unattended with a child or infant or even an animal (e.g., a pet) inside. More broadly, such dangers are generally present when children or animals are left in enclosed spaces without sufficient ventilation or cooling. To the extent possible, it would also be desirable to provide such notifications using technology which is either already included in or which may easily be adapted for use in automotive interiors.

Various aspects relate generally to the use of channel state information (CSI) for the detection of the presence of living beings, such as human or animal presence, and more particularly the presence of children or infants, in unattended automotives or other enclosed spaces. A transmitter in the interior of the enclosed space, such as, for example, an automotive interior, may send predetermined sequences of pilot signals which are received by one or more receivers within the enclosed interior space, resulting in the generation of CSI data representing information about objects within the enclosed space, and about changes to the placement and state of such objects. Aspects of the present disclosure may use such CSI to train a machine learning model, such as a neural network, to detect the presence of living beings, and more particularly adult, child, and/or infant breathing, within the enclosed space, such as an automotive interior. The spectral content of such CSI data may be particularly useful for detecting such presence, and therefore the spectral content of the CSI data may be used for training the machine learning model, such as by performing a Fast Fourier Transform or otherwise determining the spectral content of the CSI data. These and more aspects of the present disclosure are described in more detail below.

Particular implementations of the subject matter described in this disclosure can be implemented to realize one or more of the following potential advantages. By leveraging Wi-Fi transmitters and receivers which are already commonly used in new automotives to gather CSI data for use in detecting living being presence, aspects of the present disclosure can provide a simple and low-cost solution to most new and existing automotives. By using the spectral content of the CSI data for training a machine learning model and then using the trained machine learning model to identify the presence of, for example, a child or infant in an unattended automotive, and then notifying a user when such a presence is detected, aspects of the present disclosure can prevent serious injury or death to children or infants better than existing solutions, which may rely on visual or audio data.

Merely for purposes of discussion and not limitation, the present disclosure will refer to humans (adults, children, and infants) as exemplary living beings to illustrate various aspects of the present invention. Additionally, the present disclosure will refer to the interior of a vehicle or automotive as an exemplary enclosed space. However, some implementations of the present invention can be used to detect the presence of any suitable type of living being capable of breathing, including humans, pets, animals, etc., in the interior of any appropriate enclosed space. For example, the present invention can detect the presence of a dog or other pet or animal left unattended in cage or crate.

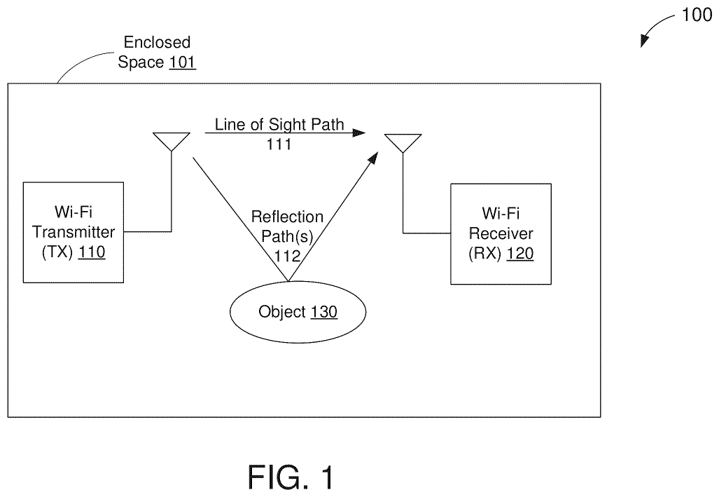

FIG. 1 shows an example system 100 which may gather channel state information (CSI) data in an enclosed space, according to some implementations. The system 100 is shown to include a Wi-Fi transmitter (TX) 110, a Wi-Fi receiver (RX) 120, and an object 130. The TX 110 may be any suitable transmitter including one or more antennas and capable of transmitting wireless signals within the enclosed space 101. Similarly, the RX 120 may include one or more receivers coupled to one or more antennas and capable of receiving signals transmitted by the TX 110 within the enclosed space 101.

The TX 110 may transmit a known sequence of signals, also known as a pilot sequence, which is received by the RX 120, and channel conditions, such as the channel matrix, of the enclosed space 101 may be estimated based on the combined knowledge of the pilot sequence and the corresponding signals received at the RX 120. For example, signals transmitted between the TX 110 and the RX 120 may be received along a line of sight path 111, or along one or more reflection paths 112 after having been reflected off of one or more objects 130 in the enclosed space 101. The CSI data gathered in this manner may represent the combined effect of scattering, fading, power decay with distance, and other features relating to the status of the enclosed space 101.

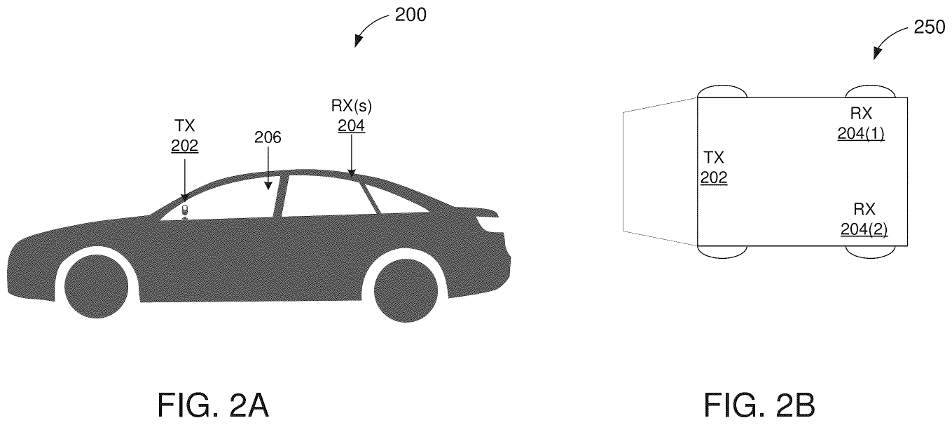

FIG. 2A shows a side view of an example environment 200 in which a Wi-Fi transmitter and one or more Wi-Fi receivers may be deployed within an automotive for detecting human presence within the automotive based on gathered CSI data, in accordance with some implementations. In some implementations, a TX 202 and one or more RX(s) 204 may be deployed within the automotive interior 206. For example, the TX 202 may be deployed in or near the front of the automotive interior 206, such as being near or co-located with a stereo interface, or instrument panel of the automotive. In some aspects, the RX(s) 204 may be deployed towards the rear of the automotive interior 206, such as being deployed along or near a ceiling above a backseat of the automotive interior.

FIG. 2B shows a top down view of an example environment 250 in which a Wi-Fi transmitter and one or more Wi-Fi receivers may be deployed within an automotive for detecting human presence within the automotive based on gathered CSI data, in accordance with some implementations. Similarly to FIG. 2A, the TX 202 is shown located towards the front of the automotive, while two receivers, RX 204(1) and RX 204(2) are deployed towards the rear of the automotive. For example, the RX 204(1) is shown on the right side of the rear of the automotive, while the RX 204(2) is shown on the left side of the rear of the automotive.

While FIGS. 2A-2B show an arrangement of transmitters and receivers which Applicant has found to work well with the techniques described in the present disclosure, other arrangements of the transmitters and receivers may be implemented without departing from the scope of the example implementations. For example, the TX 202 could be deployed towards the rear of the automotive interior 206, while the RX 204(1) and RX 204(2) could be deployed towards the front of the automotive interior 206, or a different number of RX(s) 204 could be deployed rather than the one shown in FIG. 2A or the two shown in FIG. 2B.

In some aspects, the RX(s) 204 may each be a suitable directional antenna configured to boost reception along a line of sight path of its antennas.

For example, one suitable receiver may be configured to receive signals in an approximately 50 degree arc as measured from the top to the bottom of the automotive interior 206. Similarly, a suitable receiver may be configured to receive signals in an approximately 25 degree arc as measured from the left to the right of the automotive interior 206. Other suitable receivers may have other directionality, such as having narrower or wider arcs. In some aspects, the TX 202 may transmit omnidirectionally.

In some aspects, the TX 202 may transmit the pilot sequence on a 5 GHz carrier frequency and over a 40 MHz bandwidth, although other suitable carrier frequencies and bandwidths can be used depending on the Wi-Fi signaling technique (e.g., 6 GHz carrier frequency and 20 MHz bandwidth). In some aspects, the pilot sequence may be transmitted across a plurality of subcarriers, such as 128 subcarriers or the like depending on the carrier frequency and bandwidth used, and the CSI data determined for each subcarrier may be a complex number having a magnitude and a phase. In some aspects, the phase may be random, and therefore aspects of the present disclosure may focus on the magnitude. In some aspects, a predetermined number of pilot sequences may be transmitted per unit time, such as transmitting and receiving 15 CSI packets per second, although greater or fewer packets may be exchanged per second without departing from the scope of this disclosure. One benefit of exchanging such a comparatively small number of packets per second is that the example implementations may be performed as a secondary function of another Wi-Fi enabled device. For example, the TX 202 or the RX(s) 204 may have a primary function of media streaming, recording security footage, and so on, and still be capable of exchanging CSI packets for detecting unattended children or infants within the automotive interior.

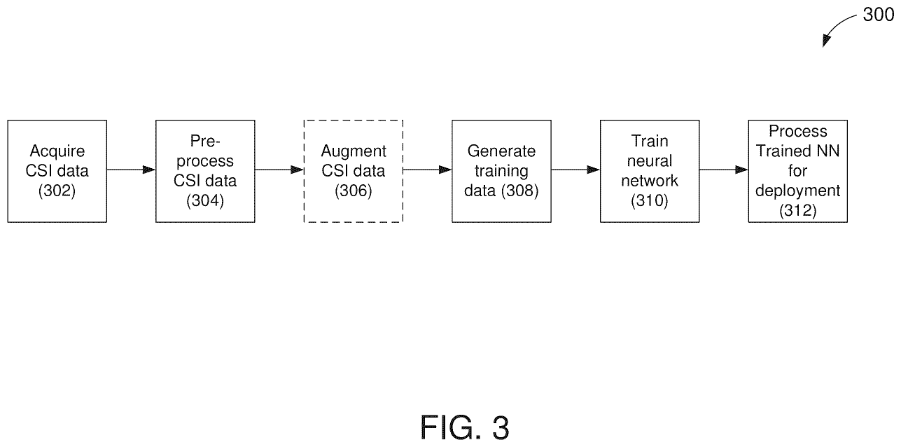

FIG. 3 shows an example process flow 300 for training a neural network to detect living beings in an enclosed space, in accordance with some implementations. For example, human presence may include the presence or absence of an adult, the presence or absence of a child or infant, the presence or absence of a pet, and so on. The process flow 300 may be performed by any suitable computing device including or coupled to a neural network.

At block 302, the computing device may acquire CSI data corresponding to the enclosed space. In some aspects, the CSI data may be gathered using the environments 200 and 250 of FIGS. 2A-2B. In order to gather sufficiently varied data for training, the acquired CSI data may be captured in a variety of test cases, including the presence and absence of adults within the enclosed space, including the presence and absence of infants within the enclosed space, and so on. For example, such test cases may include an adult sleeping in a plurality of positions within the enclosed space, an infant sleeping in a plurality of positions within the enclosed space (such as on a seat, in a seat well, in various positions on the rear seat, and so on in an automotive interior), an adult typing on a phone, an adult lying down, an adult performing one or more large motions within the enclosed space, such as waving their arms, and an empty enclosed space.

Each of these test cases may be maintained for a specified duration while CSI is gathered. In some aspects, this duration may be a multiple of 15 seconds.

In addition, CSI data may be captured for a plurality of conditions where no one is present within the enclosed space, to better identify external interference which should not be detected as a living presence. Such interference may be referred to as “immunity cases.” Some examples of immunity cases may be such as when a person is walking outside of the enclosed space, peeking into the enclosed space, such as through a window, waving their hands outside of the enclosed space, leaning on a wall adjacent to the enclosed space, or when there is other motion nearby the enclosed space, such as when the enclosed space is an automotive interior and a second automotive pulls up alongside the automotive. In some further aspects, such immunity cases may also include the presence of an object such as a balloon, or a variety of conditions tied to the identity of the enclosed space, such as, when the enclosed space is an automotive interior, starting up the automotive, operation of the windshield wipers of the automotive, adjustment of the rear view mirrors of the automotive, or vibration or a ringtone of a phone being triggered within the automotive, and so on.

In block 304, the acquired CSI data may be pre-processed to emphasize relevant features of the CSI data. For example, changes in amplifier gain in the transmitter may cause unwanted changes in the received CSI data. To compensate for such changes in amplifier gain, the received CSI data may be mean-normalized.

Additionally, to better focus on changes over time in the CSI data, background subtraction may be performed on the received CSI data. For example, a mean of the CSI data may be computed over a specified period of time, for example 15 seconds, and that computed mean may be subtracted from the CSI data corresponding to that specified period of time.

Additionally, corruption of portions of the CSI data may be detected by temporary jumps in the CSI data over a window encompassing one or more previous samples of the CSI data and one or more future samples of the CSI data. For example, such a window may have a duration of half a second, although other durations are possible without departing from the scope of this disclosure. In some aspects, pre-processing the CSI data may include determining, for each frame of CSI data, the mean of the absolute deviation with respect to the previous frame of CSI data. If this deviation exceeds a threshold for less than a specified number of frames, such as up to three frames, and then returns to a value less than the threshold, then the frames where the deviation exceeds the threshold are considered to be corrupted frames. Frames considered as corrupted frames may not be used for inferencing by the neural network or used for training the neural network. In contrast, when the deviation exceeds the threshold for more than the specified number of frames, then the frames may not be considered as corrupted but instead considered valid and may be used for inferencing or for training the neural network.

In block 306, the pre-processed CSI data may optionally be augmented to artificially generate new data from the pre-processed CSI data. For example, the pre-processed CSI data may be augmented by generating one or more augmented data sets wherein the CSI data is sped up or slowed down by one or more predetermined amounts. In some aspects, the sped up data sets may speed up the CSI data by, for example, up to 3 times its natural speed, while the slowed down data sets may slow down the CSI data to, for example, 0.75 times its natural speed. However, the data sets may be sped and slowed by any suitable amount. In some aspects, the pre-processed CSI data may be augmented by swapping the antennas of the CSI data. For example, with respect to FIG. 2B, the CSI data corresponding to RX 204(1) may be exchanged with the CSI data corresponding to RX 204(2). In some aspects, one or more augmented data sets may be generated by swapping groups of subcarriers, or by flipping the subcarriers across the channel dimension within each group of subcarriers. In some aspects, the CSI data corresponding to the presence of an adult or the presence of a child or infant may be scaled, such as scaling by one or more amounts between 0.75 and 1.25. In some aspects, subcarriers may be rolled to generate one or more augmented data sets. For example, the neighbors of a subcarrier may be maintained while moving the subcarrier, such as moving the subcarrier by a random or pseudorandom amount. In some aspects, the CSI data may be reversed across the time dimension. Further, in some aspects, one or more augmented data sets may be generated by linearly combining one or more sets of CSI data corresponding to different test cases, such as linearly combining CSI data corresponding to an empty automotive with CSI data corresponding to human presence within the automotive.

In block 308, training data for training the neural network is generated. While the CSI data contains time domain information about the state of the environment of the enclosed space, Applicant has determined that the spectral content of this CSI data is more useful for detecting the presence of a sleeping child or infant, and therefore the training data may be generated based on this spectral content. Thus, in accordance with example implementations, after pre-processing the CSI data, and optionally augmenting the CSI data, its spectral content may be determined, for example, by taking a Fast Fourier Transform (FFT) of the CSI data. More particularly, the FFT may be computed for each subcarrier of the CSI data. In some aspects, the magnitude of this computed FFT, rather than its phase, may be used for generating the training data. Using such spectral data for generating the training data may allow for signals of interest, such as a signal corresponding to a breathing child or infant, to be localized to a narrow frequency band.

In block 310, after pre-processing the CSI data, and generating the frequency domain representation of the pre-processed CSI data, the frequency domain representation of the CSI data may be used to train the neural network. In some aspects, the input size may be 1×114×208, while in some other implementations the input size may differ. In some aspects, the neural network may include 7 convolution layers, which may include 4 convolutions with a stride of 2. In some aspects, the neural network may include 2 fully connected layers. In some other aspects, the neural network may have a different number of convolution layers, a different stride, a different number of fully connected layers, or use a different architecture altogether. For example, the neural network may have an architecture such as a recurrent neural network (RNN), a long short-term memory (LSTM) neural network, a neural network using transformer model neural network, or a convolutional neural network (CNN) having a different topology than discussed above. In some aspects, the loss function for training the neural network may be a categorical cross entropy loss, with a cosine learning rate. In some other aspects, a different loss function may be used without departing from the scope of this disclosure. In some aspects, the neural network may be configured to have two outputs, a first output corresponding to the presence or absence of a living being within the enclosed space, and a second output corresponding to the presence or absence of a sleeping child or infant within the enclosed space.

Note that while the previous description describes a single neural network being trained to generate two different outputs, that in some other implementations two different neural networks may be employed here. A first neural network may be trained as described above to generate a first output indicating whether or not presence is detected, such as human presence or the presence of another living being, while a second neural network may be trained to generate a second output indicating whether or not the presence of a child or infant.

After the neural network has been trained, it may be processed for deployment. For example, data representing the trained neural network may be installed in a computing device within an automotive, such as by being transmitted wired or wirelessly to the computing device by an end user of the automotive, or by being installed in the computing device in a factory or dealer setting prior to sale of the automotive.

After the trained neural network has been deployed to a computing device within an enclosed space such as an automotive, the trained neural network may be used for detecting the presence of living beings or the presence of children or infants within the enclosed space, such as when the automotive is parked and unattended.

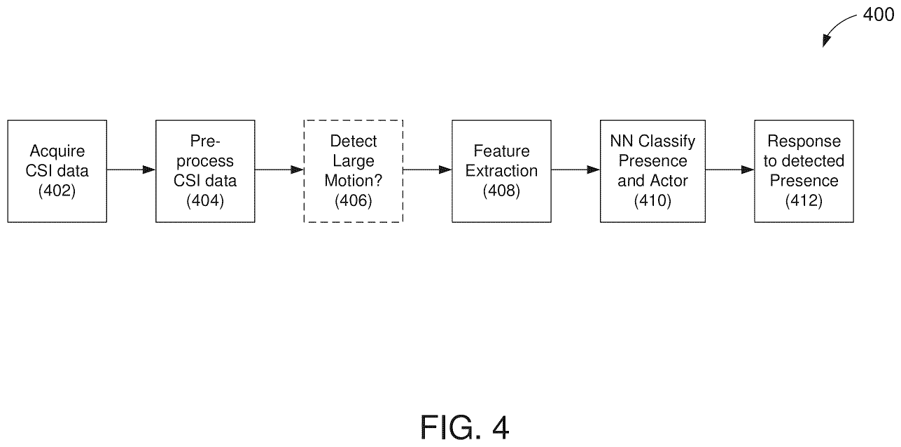

FIG. 4 shows an example process flow 400 depicting the use of a trained neural network for detecting living beings within an enclosed space, in accordance with some implementations. The process flow 400 may be performed by any suitable computing device included within or coupled to the enclosed space and to a neural network trained to detect a presence of living beings as discussed above with respect to FIG. 3. For purposes of illustration and not limitation, the process flow 400 may be performed by a computing device coupled to or incorporated within a stereo or other entertainment system installed within the enclosed space.

In block 402, the computing device acquires CSI data based at least in part on a sequence of signals received at one or more receivers located in the enclosed space. In some aspects, the CSI data may be gathered using the environments 200 and 250 of FIGS. 2A-2B. For example, a transmitter located within the enclosed space, such as the TX 202, may transmit a known sequence of signals, such as a series of pilot signals, as discussed above. This sequence of signals may be received by one or more receivers within the enclosed space, such as the RX(s) 204, RX 204(1) and RX 204(2), or another suitable one or more receivers capable of receiving the sequence of signals and providing data to the received sequence of signals to the computing device.

In block 404, the computing device pre-processes the acquired CSI data. For example, the pre-processing may compensate for changes in amplifier gain, may perform background subtraction, and may identify and corrupted portions of the CSI data as discussed above with respect to FIG. 3. In some aspects, the same pre-processing steps are performed when using the trained neural network as were performed training the neural network.

In block 406, the computing device may optionally determine whether or not large motion is detected within the enclosed space. For example, similarly to the way in which corrupted frames of CSI data are detected, for each frame of CSI data, a mean of the absolute deviation of the CSI data with respect to the previous frame may be determined. In some aspects, large motion may be detected in response to this deviation exceeding a threshold deviation for at least a specified number of consecutive frames. In some aspects, this specified number of frames may be five. In some aspects, detecting large motion within the enclosed space interior may indicate living presence within the vehicle without requiring the use of the neural network. For example, large motion may indicate the presence of one or more persons within the enclosed space, indicating that there is no child left unattended in the enclosed space.

In block 408, suitable features are extracted from the pre-processed CSI data. For example, as discussed above, the features may be generated based on the spectral content of the pre-processed CSI data, for example by taking a Fast Fourier Transform (FFT) of the CSI data. More particularly, the FFT may be computed for each subcarrier of the CSI data. In some aspects, the magnitude of this computed FFT, rather than its phase, may be used for generating the training data. In some further examples, a two-dimensional FFT may be performed on the pre-processed CSI data, using time as one dimension and subcarrier index as the second dimension. For such two-dimensional FFTs, the magnitudes may again be used as the features.

In block 410, the computing device uses the trained neural network to classify presences and actors within the enclosed space. More particularly, the neural network may determine whether or not living presence is detected, and may classify the living presence detected as being an adult human being or detected as a child or infant.

While the process flow 400 of FIG. 4 is shown as a single path, in some implementations the process flow 400 may have branching paths. For example, in some aspects, if large motion is detected in block 406, then the process flow 400 may omit the use of the neural network in block 410, and may move on to block 412, concluding that living presence is detected within the vehicle, and that the neural network is not required to detect this living presence.

In block 412, after the neural network has determined whether or not living presence is detected within the enclosed space and characterized that presence as adult or child/infant presence, the computing device may determine whether or not to respond to the determinations of the neural network, and if so, what form that response should take. For example, when the enclosed space is a vehicle interior, the computing device can cause the vehicle to generate a warning or alert, such as flashing one or more of the vehicle's lights, activating the horn and/or car alarm, or other appropriate vehicle-based notification. In some aspects, the computing device may be configured to transmit notifications (e.g., one or more messages or the like) to a second computing device. In some aspects, this second computing device may be a cellular phone, tablet computer, or another computing device owned or operated by a person associated with the vehicle, such as a person who owns, rents, or leases the vehicle. For example, the second computing device may execute one or more applications capable of receiving and displaying or otherwise providing a notification (visual and/or aural) that a living presence is detected within the vehicle, that a child or infant presence is detected within the vehicle, that a child or infant presence is detected within the vehicle without the corresponding detection of large motion within the vehicle, and so on. Thus, a person owning or operating the vehicle may be notified to ensure that a child or infant has not been left unattended in the vehicle.

In some other aspects, the second computing device may be a computing device associated with a monitoring service, such as a security monitoring service. In some aspects, after enabling a security system associated with the vehicle, when a child or infant is detected within the vehicle, a notification may be sent to the security monitoring service.

After concluding the process flow 400, the computing device may perform one or more post-processing steps, not shown in FIG. 4 for simplicity. For example, the outputs of the neural network may be averaged over time. In some aspects, the window of time used for the averaging may be reset when a change of state is detected, such as a change from detecting presence to detecting no presence, or vice versa. In some aspects, the averaging window may also be reset whenever large motion is detected after no presence is detected for a threshold period of time or number of CSI packets. This may correspond to resetting the averaging window in response to persons entering the vehicle after a sufficiently long duration where the vehicle is detected to be empty. The averaging window may also be reset in response to detecting that the vehicle is empty (no presence detected) within a threshold period of time after large motion is detected. This may correspond to persons exiting after parking the vehicle.

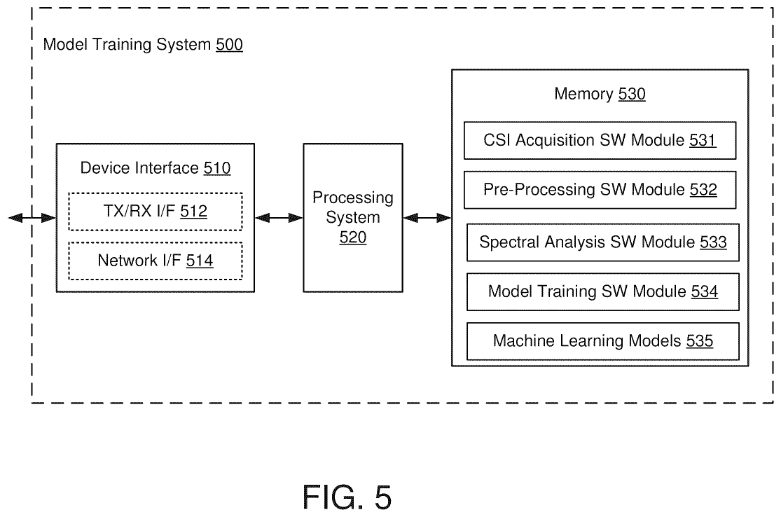

FIG. 5 shows a block diagram of an example model training system 500, according to some implementations. The model training system 500 is configured to train a machine learning model, such as a neural network or the like, to detect presences of living beings in an enclosed space based on captured CSI data. In some implementations, the model training system 500 may be one example of a computing system configured to perform the process flow 300 described with respect to FIG. 3.

The model training system 500 includes a device interface 510, a processing system 520, and a memory 530. The device interface 510 is configured to communicate with one or more transmitters or receivers, or to communicate via one or more networks. In some aspects, the device interface 510 may include a TX/RX interface (I/F) 512 configured to communicate with one or more transmitters or receivers, such as the TX 202 and the RX(s) 204 or RX 204(1) and RX 204(2), and a network interface (I/F) 514 configured to communicate with one or more networks (for example to obtain CSI data via the one or more networks).

The memory 530 may include a non-transitory computer-readable medium (including one or more nonvolatile memory elements, such as EPROM, EEPROM, Flash memory, or a hard drive, among other examples) that may store at least the following software (SW) modules:
a CSI acquisition SW module 531 to acquire CSI data for training the machine learning models 535;
a pre-processing SW module 532 to pre-process or augment the CSI data acquired by the CSI acquisition SW model 532;
a spectral analysis SW module 533 to generate training data for training the machine learning models 535 based on a spectral analysis of the pre-processed CSI data, such as an FFT of the pre-processed CSI data; and
a model training SW module 534 to train the machine learning models 535 based on the training data generated by the spectral analysis SW module 533.

Each software module includes instructions that, when executed by the processing system 520, causes the model training system 500 to perform the corresponding functions. The memory 530 may also include one or more machine learning models 535 to be trained by the model training SW module 534. The machine learning models 535 may include one or more neural networks, which may have any suitable architecture, such as a feedforward architecture or a recurrent architecture.

The processing system 520 may include any suitable one or more processors capable of executing scripts or instructions of one or more software programs stored in the model training system 500 (such as in the memory 530).

For example, the processing system 520 may execute the CSI acquisition SW module 531 to acquire CSI data for training the machine learning models 535. The processing system 520 also may execute the pre-processing SW module 532 to pre-process or augment the CSI data acquired by the CSI acquisition SW model 532. The processing system 520 may also execute the spectral analysis SW module 533 to generate training data for training the machine learning models 535 based on a spectral analysis of the pre-processed CSI data, such as an FFT of the pre-processed CSI data. The processing system 520 may also execute the model training SW module 534 to train the machine learning models 535 based on the training data generated by the spectral analysis SW module 533.

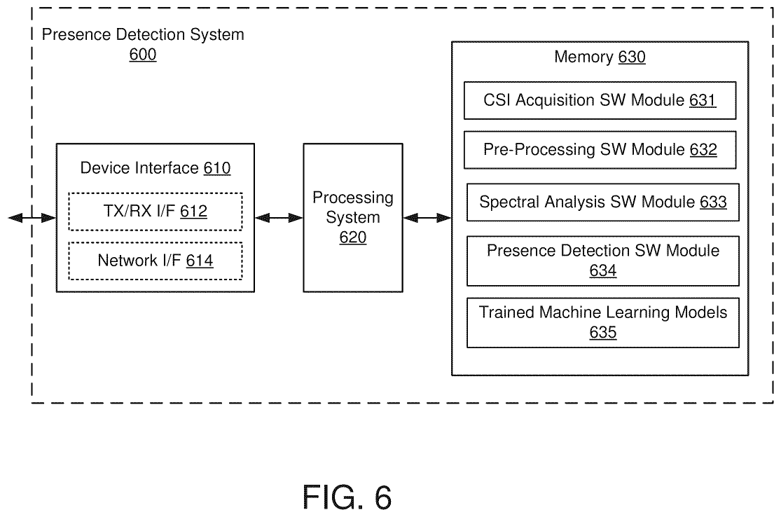

FIG. 6 shows a block diagram of an example presence detection system 600, according to some implementations. The presence detection system 600 is configured to use a trained machine learning model, such as a neural network or the like, to detect presences of living beings in an enclosed space based on captured CSI data. In some implementations, the presence detection system 600 may be one example of a computing system configured to perform the process flow 400 described with respect to FIG. 4.

The presence detection system 600 includes a device interface 610, a processing system 620, and a memory 630. The device interface 610 is configured to communicate with one or more transmitters or receivers, or to communicate via one or more networks. In some aspects, the device interface 610 may include a TX/RX interface (I/F) 612 configured to communicate with one or more transmitters or receivers, such as the TX 202 and the RX(s) 204 or RX 204(1) and RX 204(2), and a network interface (I/F) 614 configured to communicate with one or more networks (for example to obtain CSI data via the one or more networks).

The memory 630 may include a non-transitory computer-readable medium (including one or more nonvolatile memory elements, such as EPROM, EEPROM, Flash memory, or a hard drive, among other examples) that may store at least the following software (SW) modules:
a CSI acquisition SW module 631 to acquire CSI data for which human presence is to be detected using the trained machine learning models 635;
a pre-processing SW module 632 to pre-process or augment the CSI data acquired by the CSI acquisition SW model 632;
a spectral analysis SW module 633 to generate spectral data for providing to the trained machine learning models 635, corresponding to the pre-processed CSI data, such as an FFT of the pre-processed CSI data; and
a presence detection SW module 634 to use the trained machine learning models 635 to detect human presence in the spectral data generated by the spectral analysis SW module 633 and to perform any required post-processing operations.
   Each software module includes instructions that, when executed by the processing system 620, causes the presence detection system 600 to perform the corresponding functions. The memory 630 may also include one or more trained machine learning models 635 which have been trained to detect human presence in spectral data corresponding to pre-processed CSI data, such as being trained using the process flow 300. The trained machine learning models 635 may include one or more neural networks which may have any suitable architecture, such as a feedforward architecture or a recurrent architecture.

The processing system 620 may include any suitable one or more processors capable of executing scripts or instructions of one or more software programs stored in the presence detection system 600 (such as in the memory 630). For example, the processing system 620 may execute the CSI acquisition SW module 631 to acquire CSI data for which human presence is to be detected using the trained machine learning models 635. The processing system 620 also may execute the pre-processing SW module 632 to pre-process or augment the CSI data acquired by the CSI acquisition SW model 632. The processing system 620 may also execute the spectral analysis SW module 633 to generate spectral data for providing to the trained machine learning models 635, corresponding to the pre-processed CSI data, such as an FFT of the pre-processed CSI data. The processing system 620 may also execute the presence detection SW module 634 to use the trained machine learning models 635 to detect human presence in the spectral data generated by the spectral analysis SW module 633 and to perform any required post-processing operations.

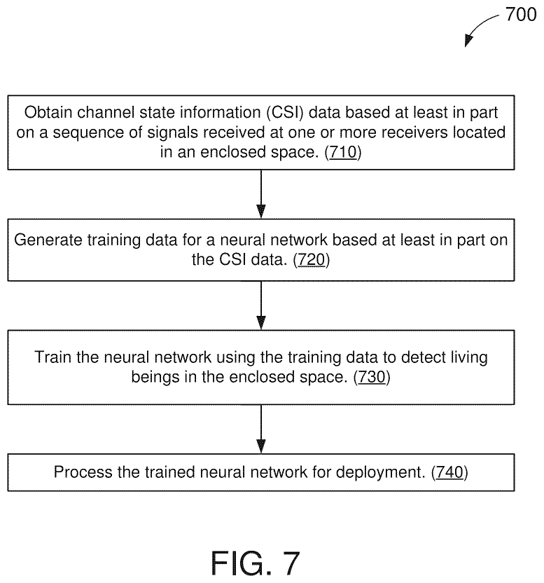

FIG. 7 shows an illustrative flowchart depicting an example operation 700 for detecting living beings in an enclosed space, in accordance with some implementations. In some implementations, the example operation 700 may be performed by a model training system, such as the model training system 500 of FIG. 5.

The model training system 500 obtains channel state information (CSI) data based at least in part on a sequence of signals received at one or more receivers located in an enclosed space (710). In some aspects, the device interface 510 and the processing system 520 executing the CSI acquisition SW module 531 can be used to obtain the channel state information.

The model training system 500 then generates training data for a neural network based at least in part on the CSI data (720). In some aspects, the processing system 520 executing the pre-processing SW module 532 and the spectral analysis SW module 533 can be used to generate the training data.

The model training system 500 then trains the neural network using the training data to detect living beings in the enclosed space (730). In some aspects, the processing system 520 executing the model training SW module 534 and training the machine learning models 535 can be used to train the neural network.

The model training system 500 then processes the trained neural network for deployment (740). In some aspects, one or more of the device interface 510, the network interface 514, the processing system 520, and the memory 530 can be used to deploy the trained neural network.

In some aspects, the CSI data is based at least in part on a pilot signal transmitted by a transmitter and received by at least one of the one or more receivers.

In some aspects, generating the training data in block 720 includes pre-processing the CSI data. In some aspects, pre-processing the CSI data includes determining an average of the CSI data over a predetermined time period, and subtracting the average of the CSI data from each signal of the sequence of signals corresponding to the predetermined time period. In some aspects, pre-processing the CSI data includes normalizing the CSI data based on an average value of the CSI data. In some aspects, pre-processing the CSI data includes augmenting the CSI data generating one or more additional sets of CSI data based on the CSI data. In some aspects, generating the one or more additional sets of CSI data includes generating one or more sped up CSI data sets by altering a timing of the CSI data to have a faster timing, or generating one or more slowed down CSI data sets by altering the timing of the CSI data to have a slower timing. In some aspects, the one or more receivers include two receivers, and the one or more additional sets of CSI data are generated by assigning a first CSI data signal received at a first receiver of the two receivers to a second receiver of the two receivers, and assigning a second CSI data signal received at the second receiver to the first receiver.

In some aspects, generating the training data in block 720 includes generating the training data based on a spectral analysis of the CSI data. In some aspects, the training data is based on a Fast Fourier Transform (FFT) of the CSI data. In some aspects, the training data is based on a magnitude portion of the FFT of the CSI data. In some aspects, an FFT is calculated for each subcarrier of the CSI data.

In some aspects, training the neural network in block 720 includes training the neural network to detect a human breathing in the enclosed space. In some aspects, detecting the human breathing in the enclosed space includes detecting an infant breathing in the vehicle.

In some aspects, the CSI data obtained in block 710 is obtained in the presence of a plurality of test cases including various circumstances within or adjacent to the enclosed space. In some aspects, the plurality of test cases include one or more test cases where an infant is present in the enclosed space.

In some aspects the one or more test cases where the infant is present in the enclosed space include at least a first test case where the infant is on a seat in the enclosed space and a second test case where the infant is on a floor in the enclosed space. In some aspects, the enclosed space is an interior of a vehicle and the plurality of test cases include one or more test cases corresponding to motion outside of the vehicle, and wherein training the neural network in block 730 includes training the neural network not to detect living beings in the vehicle in response to CSI data corresponding to the motion outside of the vehicle.

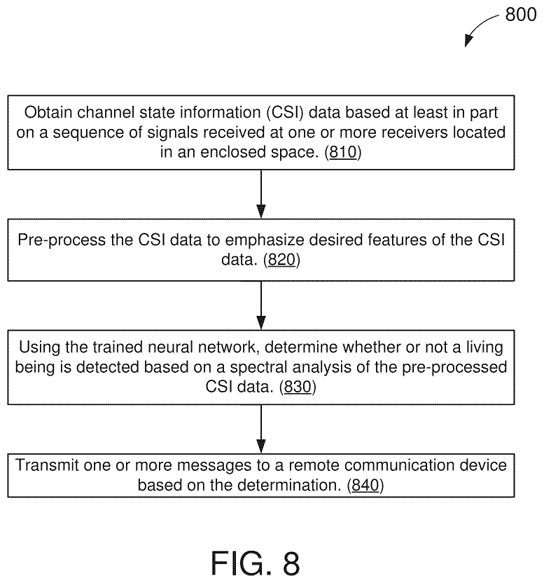

FIG. 8 shows an illustrative flowchart depicting an example operation 800 for detecting human presences in an interior of a vehicle, in accordance with some implementations. In some implementations, the example operation 800 may be performed by a presence detection system, such as the presence detection system 600 of FIG. 6.

The presence detection system 600 obtains channel state information (CSI) data based at least in part on a sequence of signals received at one or more receivers located in an interior of a vehicle (810). In some aspects, the TX 202 and the RX(s) 204 or RX 204(1) and RX 204(2) of FIGS. 2A-2B or the device interface 610, along with the processing system 620 executing the CSI acquisition SW module 631 of FIG. 6 can be used to obtain the channel state information.

The presence detection system 600 then pre-processes the CSI data to emphasize desired features of the CSI data (820). In some aspects, the processing system 620 executing the pre-processing SW module 632 can be used to pre-process the CSI data.

The presence detection system 600 then uses the trained neural network to determine whether or not a human presence is detected within the vehicle based on a spectral analysis of the pre-processed CSI data (830). In some aspects, the processing system 620 executing the spectral analysis SW module 633 or the presence detection SW module 634, along with the trained machine learning models 635 can be used to determine whether or not the human presence is detected.

The presence detection system 600 then transmits one or more messages to a remote communication device based on the determination (840). In some aspects, one or more of the device interface 610, the network interface 614, the processing system 620, and the memory 630 can be used to transmit one or more messages or otherwise provide a suitable notification, warning, alert, or the like to the user of the vehicle or other third party.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosure.

The methods, sequences or algorithms described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

In the foregoing specification, embodiments have been described with reference to specific examples thereof. It will, however, be evident that various modifications and changes may be made thereto without departing from the broader scope of the disclosure as set forth in the appended claims. The specification and drawings are, accordingly, to be regarded in an illustrative sense rather than a restrictive sense.

What is claimed is:

1. A method for training a neural network to detect living beings in an enclosed space, the method comprising:
obtaining channel state information (CSI) data based at least in part on a sequence of signals received at one or more receivers located in the enclosed space;
generating training data for the neural network based at least in part on the CSI data;
training the neural network using the training data to detect living beings in the enclosed space; and
processing the trained neural network for deployment.

2. The method of claim 1, wherein the CSI data is based at least in part on a pilot signal transmitted by a transmitter and received by at least one of the one or more receivers.

3. The method of claim 1, wherein generating the training data comprises pre-processing the CSI data.

4. The method of claim 3, wherein pre-processing the CSI data comprises determining an average of the CSI data over a predetermined time period, and subtracting the average of the CSI data from each signal of the sequence of signals corresponding to the predetermined time period.

5. The method of claim 3, wherein pre-processing the CSI data comprises normalizing the CSI data based on an average value of the CSI data.

6. The method of claim 3, wherein pre-processing the CSI data comprises augmenting the CSI data generating one or more additional sets of CSI data based on the CSI data.

7. The method of claim 6, wherein generating the one or more additional sets of CSI data comprises generating one or more sped up CSI data sets by altering a timing of the CSI data to have a faster timing, or generating one or more slowed down CSI data sets by altering the timing of the CSI data to have a slower timing.

8. The method of claim 6, wherein the one or more receivers comprise two receivers, and wherein generating the one or more additional sets of CSI data comprises generating a receiver-switched set of CSI data by assigning a first CSI signal received at a first receiver of the two receivers to a second receiver of the two receivers, and assigning a second CSI signal received at the second receiver to the first receiver.

9. The method of claim 1, wherein generating the training data comprises generating the training data based on a spectral analysis of the CSI data.

10. The method of claim 9, wherein the training data is based on a Fast Fourier Transform (FFT) of the CSI data.

11. The method of claim 10, wherein the training data is based on a magnitude portion of the FFT of the CSI data.

12. The method of claim 10, wherein the FFT is calculated for each subcarrier of the CSI data.

13. The method of claim 1, wherein training the neural network to detect living beings in the enclosed space comprises training the neural network to detect a human breathing in the enclosed space.

14. The method of claim 13, wherein detecting the human breathing in the enclosed space comprises detecting an infant breathing in the enclosed space.

15. The method of claim 1, wherein the CSI data is obtained in a presence of a plurality of test cases comprising various circumstances within or adjacent to the enclosed space.

16. The method of claim 15, wherein the plurality of test cases comprise one or more test cases where an infant is present in the enclosed space.

17. The method of claim 16, wherein the one or more test cases where the infant is present in the enclosed space comprise at least a first test case where the infant is on a seat in the enclosed space, and a second test case wherein the infant is on a floor in the enclosed space.

18. The method of claim 15, wherein enclosed space is an interior of a vehicle, and wherein the plurality of test cases comprises one or more test cases corresponding to motion outside of the vehicle, and wherein training the neural network comprises training the neural network not to detect living beings in the vehicle in response to CSI data corresponding to the motion outside of the vehicle.

19. A computing device for training a neural network to detect living beings in an enclosed space, the computing device comprising:
at least one data processor; and
a memory storing instructions, which, when executed by the at least one data processor, cause the at least one data processor to perform operations comprising:
obtaining channel state information (CSI) data based at least in part on a sequence of signals received at one or more receivers located in the enclosed space;
generating training data for a neural network based at least in part on the CSI data;
training the neural network using the training data to detect living beings in the vehicle; and
processing the trained neural network for deployment.

20. A non-transitory computer-readable storage medium storing instructions for execution by one or more processors of a computing device, wherein execution of the instructions causes the computing device to perform operations comprising:
obtaining channel state information (CSI) data based at least in part on a sequence of signals received at one or more receivers located in an enclosed space;
generating training data for a neural network based at least in part on the CSI data;
training the neural network using the training data to detect living beings in the vehicle; and
processing the trained neural network for deployment.
